(19) United States
(12) Patent Application Publication
(10) Pub. No.: US 2026/0049650 A1
(43) Pub. Date: Feb. 19, 2026

(54) TRANSMISSION SYSTEM OF A LASER TOOL

(71) Applicant: CHANGZHOU HUADA KEJIE OPTO-ELECTRO INSTRUMENT CO., LTD, Changzhou (CN)

(72) Inventors: Ou ZHANG, Changzhou (CN); Kaifeng ZHANG, Changzhou (CN); Kai FEI, Changzhou (CN); Hao ZHOU, Changzhou (CN)

(21) Appl. No.: 19/279,390

(22) Filed: Jul. 24, 2025

(30) Foreign Application Priority Data
Aug. 13, 2024 (CN) 2024219524385

(51) Int. Cl. F16H 37/04

(52) U.S. Cl. CPC F16H 37/041

(57) ABSTRACT

The utility model provides a transmission system for a laser tool comprising a guide rail, an output wheel, a transmission structure and a drive structure. The guide rail is in fitted connection with the output wheel, the guide rail has a dovetail groove formed therein, the dovetail groove forms a closed path for defining and guiding the output wheel, an end of the output wheel that mates with the guide rail has a ring of dovetail shaped tenon that fits into a dovetail shaped groove on the guide rail, the output wheel sliding along the closed path of the guide rail upon actuation of the drive structure. The transmission structure has at least a two-stage planetary structure. The utility model improves the load carrying capacity of the transmission structure, smoothness of the output wheel, slew clearance consistency and reliability, and improves operability while reducing assembly difficulty of the transmission system.

### CROSS-REFERENCE TO RELATED APPLICATIONS

The present application claims priority to Chinese Patent Application No. CN2024219524385, filed on Aug. 13, 2024, the disclosure of which are incorporated herein by reference.

### TECHNICAL FIELD

The utility model relates to the field of construction lofting, and in particular to a transmission system of a laser tool.

### BACKGROUND

The rotating bases of traditional laser tools usually adopt single-stage or multi-stage gears in their transmission structure. This leads to low transmission accuracy, unstable transmission, significant backlash during transmission, and other problems. On the other hand, the assembly process of multi-stage gears is highly demanding, and the processing requirements for transmission parts are also very high, resulting in high costs, large size, high energy consumption, low efficiency, and high noise. Overall, the traditional structure is unable to meet the market's demand for high precision.

### DESCRIPTION

To address the deficiencies and shortcomings of the prior art described above, the present utility model provides a transmission system of a laser tool including a guide rail, an output wheel, a transmission structure, and a drive structure.

the drive structure is a power output source; the transmission structure connects the drive structure and the output wheel, the transmission structure rotates under the driving of the drive structure, and it drives the output wheel to rotate as well; the guide rail is an annular cylinder, in fitted connection with output wheel, and dovetail-shaped groove is formed on guide rail, dovetail-shaped groove defining closed path for defining and guiding output wheel;

The output wheel is an annular cylinder, an end of the output wheel cooperating with a guide rail has a ring of dovetail tenon, the dovetail tenon being embedded in a dovetail groove on a guide rail and conforming, the output wheel sliding along a closed path of the guide rail upon actuation of the drive structure, the output wheel is connected at its other end to a laser tool, and the output wheel is configured to rotate the laser tool. Wherein, the groove on the guide rail is dovetail shaped; the tenon on the output wheel is dovetail shaped such that the shape of the tenon conforms to the shape of the groove on the guide rail.

Preferably, the transmission structure having at least a two-stage planetary structure comprising a sun gear, an end cap, a first planetary gear set, a first carrier, a second carrier, a second planetary gear set, a first internal ring gear, a second internal ring gear; the first planetary gear set comprises a number of gears of identical gauge; the second planetary gear set comprises a number of gears of the same gauge; a first planetary gear shaft corresponding to the first planetary gear set is provided on a side of the first carrier facing the first planetary gear set, and a sun gear shaft is provided centrally on a side of the first carrier facing the second carrier; the second carrier has a second planetary gear shaft disposed thereon that corresponds with the second planetary gear set; the first planetary gear set being mounted on a first carrier through a first planetary gear shaft, the first planetary gear set being in meshed engagement with the sun gear and end cap forming a first stage planetary structure; the sun gear drives the first planetary gear set to rotate, and the first planetary gear set, through the first planetary gear shaft, drives the first planetary carrier to rotate; the second planetary gear set mounted on a second carrier through a second planetary gear shaft, the second planetary gear set meshing with a sun gear shaft on a first carrier, a first internal ring gear and a second internal ring gear constituting a second stage planetary; the first planetary gear carrier drives the second planetary gear set to rotate through the sun gear shaft, and the second planetary gear set in turn drives the first inner gear ring and the second inner gear ring to rotate; the outer side of the first inner gear ring is provided with teeth, the first inner gear ring engages with the output wheel through the teeth on its outer side, and the first inner gear ring drives the output wheel to rotate.

Optionally, the second internal ring gear has tooth ratio setting different from tooth ratio setting of the first internal ring gear.

Optionally, an additional internal ring gear is provided in transmission structure and the additional internal ring gear is provided in different ratio of teeth than the first internal ring gear and the second internal ring gear.

Optionally, the transmission system of the laser tool further comprises a probe, the probe is disposed on the output wheel and the drive structure in connection with the laser tool to collect status information of the output wheel and drive structure and transmit the status information to the laser tool.

A transmission system employing a laser tool provided by the present utility model, the bearing capacity of the drive structure and the smoothness of the output wheel, the revolution clearance consistency and reliability may be improved, reducing the assembly difficulty of the transmission system, but also enhancing its operability. Moreover, it can alleviate the impact damage to the gears in some special drop conditions. Data of the transmission system is collected using a probe method. This approach not only ensures the system's stability but also enhances its sealing protection, providing better dust and water resistance. Through these improvements, the overall user experience of the laser tool has been optimized.

### DESCRIPTION OF THE DRAWINGS

FIG. 1 shows a top perspective view of a transmission system of a laser tool.

FIG. 2 shows a bottom perspective view of a transmission system of a laser tool.

FIG. 3 shows an exploded view of a transmission system of a laser tool.

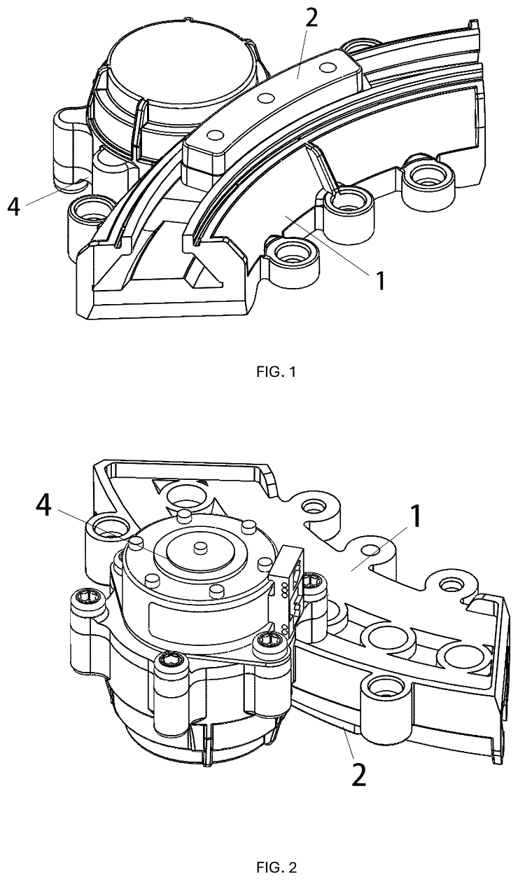

Reference numerals: 1. guide rail, 2. output wheel, 3. gear set, 4. motor, 11. housing, 31. sun gear, 32. end cap, 33. first planetary gear set, 34. first carrier, 35. second carrier, 36. second planetary gear set, 37. first internal ring gear, 38. second internal ring gear, 341. first planetary gear shaft, 342. sun gear shaft, 351. second planetary gear shaft, 41. transmission shaft.

### EMBODIMENTS

Advantages of the utility model are further illustrated below in connection with the accompanying drawings and detailed description.

Reference will now be made in detail to exemplary embodiments, examples of which are illustrated in the accompanying drawings. When the following description refers to figures, the same numbers in different figures refer to the same or similar elements unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

The terminology used herein is for the purpose of describing particular embodiments only and is not intended to be limiting of the disclosure. As used in this disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items.

In the description of the present utility model, it needs to be understood that The terms “inner”, “outer” and the like indicate orientation or positional relationships based on those shown in the drawings, it is merely for convenience in describing the utility model and simplification of the description, and it is not intended to indicate or imply that the devices or elements referred to must have a particular orientation, be constructed and operate in a particular orientation, and therefore cannot be construed as limiting the utility model.

In the description of the present utility model, unless otherwise specified and defined, it is to be understood that the terms “mounted”, “connected”, and “connected” are to be broadly understood, e.g., mechanically or electrically connected, or in communication within two elements, directly connected, or indirectly connected via an intermediate medium, and the specific meaning of the above terms can be understood by those of ordinary skill in the art as the case may be.

In the description that follows, a suffix such as “module,” “component,” or “unit” to denote an element is used merely to facilitate the description of the utility model and does not itself make a particular sense. Accordingly, “module” and “component” may be used interchangeably.

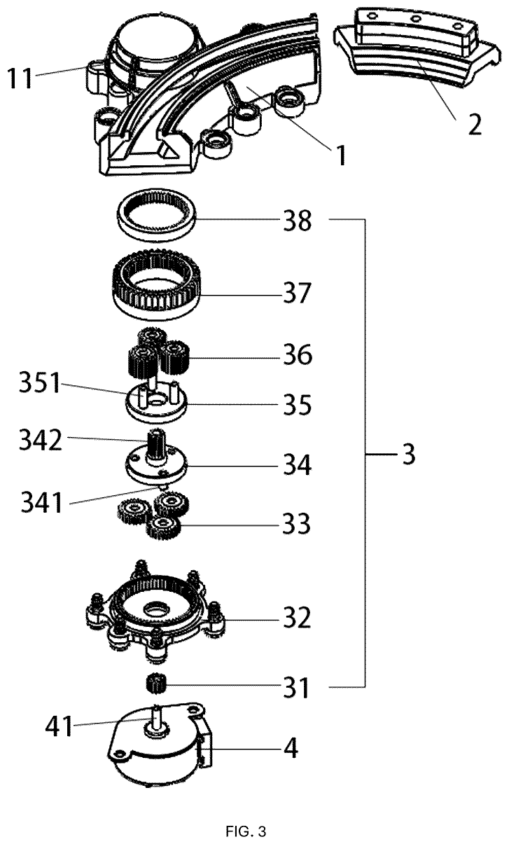

As shown in FIG. 3, the utility model provides a transmission system of a laser tool comprising a guide rail 1, an output wheel 2, a gear set 3 and a motor 4.

The guide rail 1 is an annular ring having a dovetail groove, and the dovetail groove forms an annular path that is in fitted connection with the output wheel 2 for guiding and defining the output wheel 2. And a housing 11 is provided outside the guide rail 1. Where the housing 11 meets the outside of the guide rail 1, there is a transverse slot communicating with the internal housing 11 dovetail slot with the guide rail 1.

The output wheel 2 is an annular ring and a first end of the output wheel 2 is connected to the base of the laser tool to drive the laser tool to rotate. The second end of the output wheel 2 is embedded in the slot of the rail 1 by means of a tenon. The tenon at the second end of the output wheel 2 has a dovetail shape that cooperates with the dovetail groove of the guide rail 1 so that the output wheel 2 can rotate smoothly guided by the dovetail groove of the guide rail 1. The dovetail tenon of the output wheel 2 is provided with teeth on the side close to the housing 11. The output wheel 2 is provided with a probe connected to the negative pole of the power supply. By using the electronic probe, on the one hand, the reliability of the mechanical and software components of the transmission system has been further enhanced; on the other hand, it has better sealing protection properties, enabling the transmission system to have better dust-proof and water-proof capabilities.

The gear set 3 is a two-stage planetary structure that connects the motor 4 and the output wheel 2 for transmission. The gear set 3 comprises a sun gear 31, an end cap 32, a first planetary gear set 33, a first carrier 34, a second carrier 35, a second planetary gear set 36, a first internal ring gear 37, and a second internal ring gear 38. The sun gear 31, the end cap 32, the first planetary gear set 33 and the first carrier 34 constitute a first stage planetary; the first planet carrier 34, the second planet carrier 35, the second planetary gear set 36, the first internal ring gear 37 and the second internal ring gear 38 constitute a second stage planetary structure.

The end cap 32 is arranged on the face of the motor 4 facing towards the housing 11, and on the face of the end cap 32 facing away from the motor 4 there is an annular projection, the inner side of which is provided with teeth. The end cap 32 is provided with a hole in the center of the annular protrusion.

The housing 11 cooperates with the end cap 32 to form a space to accommodate the remaining components of the gear set 3. Corresponding screw holes are provided on the housing 11 and the end cap 32, which are connected to each other by screws.

The sun gear 31 is provided on a face of the end cap 32 facing towards the housing 11.

The first planetary gear set 33 comprises three gears of identical dimensions, arranged evenly on the face of the end cap 32 facing towards the housing 11, the axis of each gear being on the same circular path. The first planetary gear set 33 revolves around the sun gear by meshing with the sun gear 31, the end cap 32. In operation of the transmission system, the sun gear 31 is the power input and the first planetary gear set 33 is the power output.

The first planet carrier 34 is disposed on a face of the first planetary gear set 33 facing away from the end cap 32; The face of the first carrier 34 towards the first planetary gear set 33 is provided with three first planetary gear shafts 341 corresponding to the positions of each gear shaft of the first planetary gear set 33; the first planetary gear set is mounted on, rotatable about, a first planetary gear shaft 341. The face of the first planet carrier 34 towards the second planet carrier 35 is provided in a centered position with a sun gear shaft 342 which meshes with the second planetary gear set 36. In operation of the transmission system, the sun gear shaft 342 is the power input and the second planetary gear set 36 is the power output.

In other embodiments, the number of gears of the first planetary gear set 33 and the number of corresponding first planetary gear shafts 341 of the first carrier 34 is greater than three.

The second planet carrier 35 is arranged on a face of the first planet carrier 34 facing away from the first planetary gear set 33. A hole is formed in the center of the second planet carrier 35 through which the sun gear shaft 342 may pass through the second planet carrier 35. The face of the second planet carrier 35 facing away from the first planet carrier 34 is evenly provided with three second planetary gear shafts 351 for mounting the second planetary gear set 36.

The second planetary gear set 36 comprises three gears of identical gauge, arranged evenly on corresponding shafts of the second planet carrier 35. The shaft centers of the gears of the second planetary gear set 36 lie on the same circular path and correspond to the position of the second planetary gear shaft 351.

In other embodiments, the number of gears of the second planetary gear set 36 and the number of the second planetary gear shaft 351 corresponding to the second planetary gear carrier 35 is greater than 3.

In other embodiments, more stages of planetary gear sets and corresponding carrier may be provided in the gear set 3, thereby further adjusting the rotational speed and torque of the gear set 3.

A first internal ring gear 37 is arranged peripherally to the second planetary gear set 36, and the outside of the first internal ring gear 37 is arranged with teeth. The first internal ring gear 37 meshes with an end of the second planetary gear set 36 near the motor 4 via teeth on the inside. In operation of the transmission system, the second planetary gear set 36 is the power input and the first internal ring gear 37 is the power output.

The first internal ring gear 37 meshes with the output wheel 2 through the slots of the housing 11 by teeth on the outside. In operation of the transmission system, the first internal ring gear 37 is the power input and the output wheel 2 is the power output. The first internal ring gear 37 is provided with an I/O interface connected probe through which the laser tool can collect data such as rotational speed of the transmission system.

A second internal ring gear 38 is provided on a face of the first internal ring gear 37 facing away from the second planet carrier 35, meshing with an end of the second planetary gear set 36 proximal to the housing 11. In operation of the transmission system, the second planetary gear set 36 is the power input and the second internal ring gear 38 is the power output. The tooth ratio arrangement between the second internal ring gear 38 and the second planetary gear set 36 is different from the tooth ratio arrangement between the first internal ring gear 37 and the second planetary gear set 36, allowing the transmission system to achieve differential functionality by adjusting the meshing conditions of the second planetary gear set 36 and the first internal ring gear 37 and the second internal ring gear 38.

In other embodiments, more additional internal ring gears may be provided and the ratio of teeth between the additional internal ring gears and the second planetary gear set 36 is different than the first internal ring gear 37 and the second internal ring gear 38, further refining the differential adjustment function.

The motor 4 is the power output source of the transmission system, outputting power to the output wheel 2 through the gear set 3. The motor 4 has a drive shaft 41 facing the housing 11. A drive shaft 41 is connected to the sun gear 31 through a hole in the end cap 32 for securing the sun gear 31. Corresponding screw holes are provided on the guide rail 1 and the motor 4, which are connected to each other by screws.

The drive shaft 41, the sun gear 31, the center of the circle in which the respective gear shafts of the first planetary gear set 33 are located, the sun gear shaft 342, the center of the second planet carrier 35, the center of the circle in which the respective gear shafts of the second planetary gear set 36 are located, the center of the first internal ring gear 37, the center of the second internal ring gear 38 are on the same axis.

When the motor is operating, the drive shaft 41 rotates, thereby driving the sun gear 31 to rotate around the drive shaft 41 as the axis. The sun gear 31 drives the first planetary gear set 33 to rotate; the rotation of the first planetary gear set 33 includes the self-rotation of each gear around the first planetary gear shaft 341 and the revolution around the axis of the sun gear 31. The first planetary gear set 33 drives the first planetary carrier 34 to rotate through the first planetary gear shaft 341, and the first planetary carrier 34 rotates around the extension line of the drive shaft 41 as the axis. The first planetary gear carrier 34 drives the second planetary gear set 36 to rotate through the sun gear shaft 342. The rotation of the second planetary gear set 36 includes the rotation of each gear around the second planetary gear shaft 351 as the axis and the revolution around the sun gear shaft 342. The second planetary gear set 36 drives the second planetary gear carrier 35 to rotate through the second planetary gear shaft 351 and also drives the first inner gear ring 37 and the second inner gear ring 38 to rotate. The first inner gear ring 37 drives the output wheel 2 to rotate, thereby causing the base of the laser tool to rotate.

The rotational speed of the first stage planetary structure is adjusted by adjusting the tooth ratios and respective radii between the sun gear 31, the annular protrusion of the end cap 32 and the first planetary gear set 33, as required.

When motor 4 rotates clockwise, drive shaft 41 also rotates clockwise. At the same time, the gears of the first planetary gear set 33 rotate clockwise while also rotating counterclockwise. The first planetary carrier rotates clockwise. The gears of the second planetary gear set 36 rotate clockwise while also rotating counterclockwise.

When motor 4 rotates counterclockwise, drive shaft 41 rotates counterclockwise as well. At the same time, each gear of the first planetary gear set 33 rotates counterclockwise while also rotating clockwise. The first planetary carrier rotates counterclockwise, and the gears of the second planetary gear set 36 rotate counterclockwise while also rotating clockwise.

By adjusting the gear ratio and radii between the sun gear shaft 342, the second planetary gear set 36 and the first inner gear ring 37, the rotational speed and rotation direction of the second-level planetary structure can be regulated.

When the first inner gear ring 37 rotates clockwise, the output wheel 2 rotates counterclockwise; when the first inner gear ring 37 rotates counterclockwise, the output wheel 2 rotates clockwise.

Among them, the rotational angular speed of the first inner gear ring 37 is less than that of the driving shaft 41, thereby reducing the rotational angular speed of the output wheel 2 and ensuring the accuracy of the base rotation. The use of the planetary gear set also reduces the axial clearance of the transmission system and the backlash between the teeth, thereby further improving the accuracy of the transmission system. Secondly, through the secondary planetary structure, the input torque required for the rotation of the transmission system is increased, enhancing the transmission capacity of the transmission system, and making the laser instrument less likely to rotate when dropped, reducing the possibility of impact damage to the laser instrument caused by the drop. At the same time, it also allows users to adjust the position of the laser tool by manually turning the output wheel. Moreover, due to the use of the secondary planetary gear set, the installation of the transmission system does not need to consider the positional coordination between different gears but only needs to be installed in the order from top to bottom.

By using dovetail grooves on the guide rail 1 and dovetail-shaped protrusions on the output wheel 2, the guide rail 1 and the output wheel 2 can have multi-faceted contact and cooperation, which can alleviate the instability problem of the output wheel during movement at a large angle and further reduce the sliding resistance caused by instability. In addition, by combining a transmission structure with multi-level planetary structure, the torque of the transmission structure can be adjusted to enhance the load-bearing capacity of the transmission system. Moreover, due to the use of the planetary structure transmission structure, smaller axial clearance and back clearance can be achieved, enabling the transmission system to achieve higher point motion accuracy. Therefore, the transmission system provided by this utility model for the laser tool can significantly improve the accuracy, stability and reliability of the laser tool during rotation.

It should be noted that the embodiments of this utility model have good practicability and do not impose any restrictions on this utility model in any form. Any person familiar with the field could modify or adapt the above-mentioned disclosed technical content to form equivalent effective embodiments. As long as they do not deviate from the technical content of this utility model, any modification or equivalent change and modification made based on the above embodiments according to the technical essence of this utility model still fall within the scope of this utility model's technical solution.

1. A transmission system of a laser tool comprising a drive structure, a transmission structure, a guide rail, and an output wheel,
the drive structure is a power output source;
the transmission structure connects the drive structure and the output wheel, the transmission structure rotates under the driving of the drive structure, and it drives the output wheel to rotate as well;
the guide rail is an annular cylinder fitted to one end of the output wheel, the guide rail having a groove, the groove defining a closed path for defining and guiding the output wheel; and
the output wheel is an annular cylinder, one end of the output wheel spliced with the guide rail having a ring of tenon that fit into grooves on the guide rail, the output wheel sliding along the closed path of the guide rail under the driving of the drive structure, the other end of the output wheel being connected to a laser tool, the output wheel configured to rotate the laser tool;
wherein the groove on the guide rail is dovetail shaped;
the tenon on the output wheel is dovetail shaped such that the shape of the tenon conforms to the shape of the groove on the guide rail.

2. The transmission system of a laser tool according to claim 1, wherein:
the transmission structure having at least a two-stage planetary structure comprises a sun gear, an end cap, a first carrier, a first planetary gear set, a second carrier, a second planetary gear set, a first internal ring gear, a second internal ring gear;
the first planetary gear set comprises a number of gears of identical gauge;
the second planetary gear set comprises a number of gears of the same gauge;
a first planetary gear shaft corresponding to the first planetary gear set is provided on a side of the first carrier facing the first planetary gear set, and a sun gear shaft is provided centrally on a side of the first carrier facing the second carrier;
the second carrier has a second planetary gear shaft disposed thereon that corresponds with the second planetary gear set;
the first planetary gear set is mounted on a first carrier through a first planetary gear shaft, the first planetary gear set is in meshed engagement with the sun gear and end cap forming a first stage planetary structure;
the sun gear drives the first planetary gear set to rotate, and the first planetary gear set, through the first planetary gear shaft, drives the first planetary carrier to rotate;
the second planetary gear set is mounted on a second carrier through a second planetary gear shaft, the second planetary gear set meshes with a sun gear shaft on a first carrier, a first internal ring gear and a second internal ring gear constitute a second stage planetary;
the first planetary gear carrier drives the second planetary gear set to rotate through the sun gear shaft, and the second planetary gear set in turn drives the first inner gear ring and the second inner gear ring to rotate; and
the outer side of the first inner gear ring is provided with teeth, the first inner gear ring engages with the output wheel through the teeth on its outer side, and the first inner gear ring drives the output wheel to rotate.

3. The transmission system of a laser tool according to claim 2, wherein the second internal ring gear has tooth ratio setting different from tooth ratio setting of the first internal ring gear.

4. The transmission system of a laser tool according to claim 2, wherein an additional internal ring gear is provided in transmission structure and the additional internal ring gear is provided in different ratio of teeth than the first internal ring gear and the second internal ring gear.

5. The transmission system of a laser tool according to claim 1, further comprising a probe;
the probe is disposed on the output wheel and the drive structure, is in connection with the laser tool to collect status information of the output wheel and drive structure and transmit the status information to the laser tool.
